(19) United States
(12) Patent Application Publication
(10) Pub. No.: US 2014/0227059 A1
(43) Pub. Date: Aug. 14, 2014

(54) PERMANENT SCREW ATTACHMENT

(71) Applicants: Pierre Blanchet, Clairvaux (FR); Stéphane Pichard, Thilouze (FR); Alain Servin, Villiers (FR); Thierry Delage, Colombes (FR)

(72) Inventors: Pierre Blanchet, Clairvaux (FR); Stéphane Pichard, Thilouze (FR); Alain Servin, Villiers (FR); Thierry Delage, Colombes (FR)

(73) Assignee: VALEO SYSTÉMES D'ESSUYAGE, Le Mesnil Saint Denis (FR)

(21) Appl. No.: 14/128,734

(22) PCT Filed: Jun. 11, 2012
(86) PCT No.: PCT/EP2012/060959

§ 371 Date: Feb. 13, 2014

(30) Foreign Application Priority Data
Jun. 28, 2011 (FR) 1155750

(51) Int. Cl. F16B 39/02

(52) U.S. Cl. CPC F16B 39/025
USPC 411/122; 29/525.11

(57) ABSTRACT

The invention relates to a method and system for permanently attaching a take-up screw (3) for taking-up the axial clearance of the armature shaft of a windscreen wiper motor. The take-up screw (3) is screwed axially into a bore (1) in the motor base (SM) until it reaches a stop position in relation to the armature shaft (6) locked on the screw, At least one surface discontinuity (2) is provided in the bore (1) and/or the thread of the screw (3), allowing the screw (3) to be screwed into the bore until it reaches the stop position. The screw (3) is screwed into the bore until the stop position is reached and a screw- and/or motor base-deformation strain (D) is applied at the discontinuity (2) in order to deform the side surface of the screw (3) and/or motor base (SM) and permanently attach the screw (3) and/or motor base by means of wedging in the discontinuity. The invention is suitable for the wind-screen wiper motors of motor vehicles.

The invention relates to a method and to a system for permanently securing a screw for compensating for the axial play of the armature shaft of a windshield wiper motor of a motor vehicle.

In motor vehicle windshield wiper motors, the armature shaft must be immobilized in the axial direction, with respect to the motor mounting base. This immobilization is usually effected by means of a screw which is screwed axially into a tapped bore of the motor mounting base as far as an abutment position with respect to the armature shaft.

Turning the screw and positioning it in abutment are performed using a screwdriver driven as a function of the current consumption of the motor under zero load.

In order to permanently secure the screw, the current technique consists in injecting, next to the screw in the abutment position, a securing resin allowing the screw to be immobilized.

This solution is adequate but has the drawback of being costly in terms of production time, notably for manufacturing on a production line, in particular because of the setting time of the resin, and is moreover not very precise.

It is an object of the present invention to overcome the aforementioned drawbacks by implementing a method and a system for permanently securing a screw for compensating for the axial play of the armature shaft of a windshield wiper motor, in which the injection of a securing resin is dispensed with.

In particular, it is another object of the present invention to implement a method and a system for permanently securing a screw for compensating for the axial play of the armature shaft of a windshield wiper motor, in which the permanent securing is effected by a quick and purely mechanical operation, replacing the resin injection operation and the phase of setting or hardening of the resin, which is costly in terms of manufacturing process time.

The method for permanently securing a screw for compensating for the axial play of the armature shaft of a windshield wiper motor, the compensating screw being screwed axially into a bore of the motor mounting base as far as an abutment position with respect to the armature shaft which is immobilized thereon, object of the invention, is noteworthy in that it consists at least in creating, in the bore and/or the thread of the screw, at least one surface discontinuity allowing the screw to be screwed into the bore as far as the abutment position; screwing the screw into the bore as far as the abutment position; and applying, at the discontinuity, a force for deforming the screw and/or the motor mounting base so as to deform the lateral surface of the screw and/or of the motor mounting base and so as to permanently secure the screw and/or the motor mounting base by jamming in the discontinuity.

The method object of the invention is moreover noteworthy in that the discontinuity is a slot or a recess created on the lateral surface of the motor mounting base or of the screw.

The method object of the invention is also noteworthy in that the operation of applying a deforming force consists in applying axially, to the assembly consisting of the screw and bore of the motor mounting base, a punch type tool comprising at least one lateral rib for deforming the screw and/or the bore by swaging into the corresponding discontinuity.

The method object of the invention is also noteworthy in that the punch type tool is mounted on a machine tool of a production line.

According to one embodiment, the method object of the invention is noteworthy in that the punch type tool is substantially circular in cross section, the tool having an end point and comprising a rib created along a generator of the substantially circular cross section, the rib continuing onto the end point.

According to another embodiment, the method object of the invention is noteworthy in that the punch type tool is substantially circular in cross section, the tool having a circular housing at its working end, the circular housing having a rib.

According to a preferred embodiment, the method object of the invention is noteworthy in that said discontinuity consists of a slot or a recess created in the lateral surface of the motor mounting base at the bore, the discontinuity being produced during molding of the motor mounting base.

The system for permanently securing a screw for compensating for the axial play of the armature shaft of a windshield wiper motor, the compensating screw being screwed axially into a bore of the motor mounting base as far as an abutment position with respect to the armature shaft which is immobilized thereon, object of the invention, is noteworthy in that it comprises at least a surface discontinuity created in the bore and/or the thread of the screw and a deformation of the screw and/or of the motor mounting base permanently securing the screw and/or the motor mounting base by jamming in the discontinuity.

The permanent securing system, object of the invention, is moreover noteworthy in that the discontinuity is a slot or a recess created on the lateral surface of the motor mounting base or of the screw.

The permanent securing system, object of the invention, is also noteworthy in that the deformation is produced by swaging the screw and/or the motor mounting base into the discontinuity.

The permanent securing system, object of the invention, is according to another embodiment noteworthy in that the screw is a hollow screw. This screw is for example made of plastic.

The permanent securing system, object of the invention, is according to another variant noteworthy in that the motor mounting base is made of Zamac or aluminum alloy.

The permanent securing system, object of the invention, is according to yet another variant noteworthy in that the discontinuity consists of a slot of the order of 5 to 8 millimeters wide.

The invention also covers a windshield wiper motor comprising an armature shaft immobilized on a screw, for compensating for the axial play of the armature shaft, which is screwed into a bore of the motor mounting base as far as an abutment position, noteworthy in that the compensating screw and/or the bore of the motor mounting base comprise at least one deformation constituting a permanent securing system as mentioned above.

The method and the system for permanently securing a screw for compensating for the axial play of the armature shaft of a windshield wiper motor, objects of the invention, are to be used in the industrical production of DC motors, in particular windshield wiper motors, in the automotive industry.

They will be better understood with reference to the description and drawings below, in which:

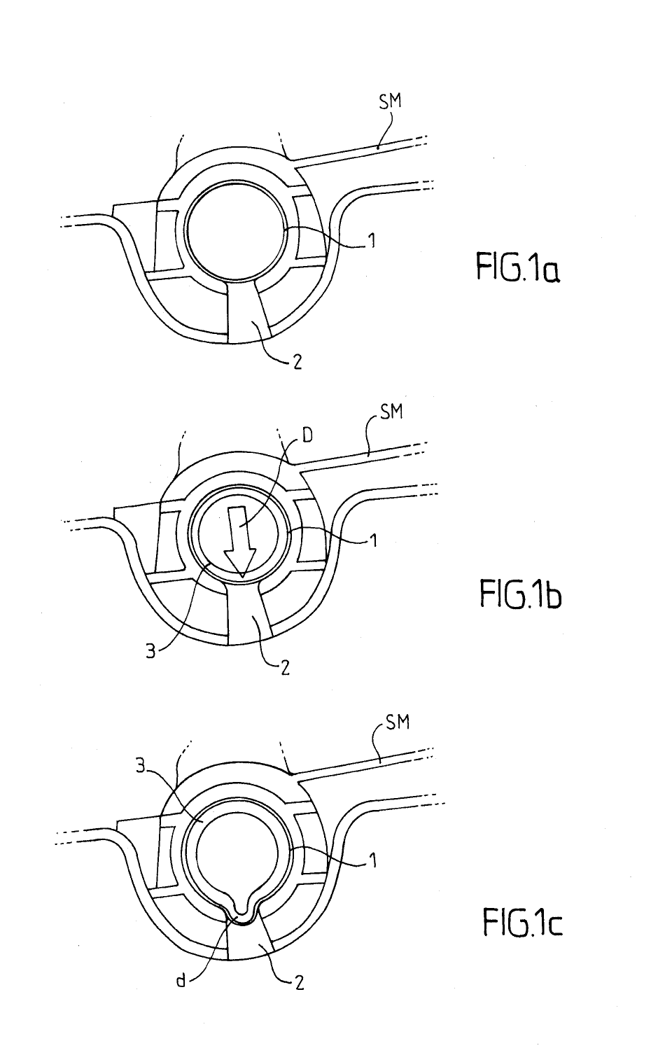

FIGS. 1a to 1c show the steps for implementing the method for permanently securing a screw for compensating for the axial play of the armature shaft of a windshield wiper motor, object of the invention, in a preferred nonlimiting implementation;

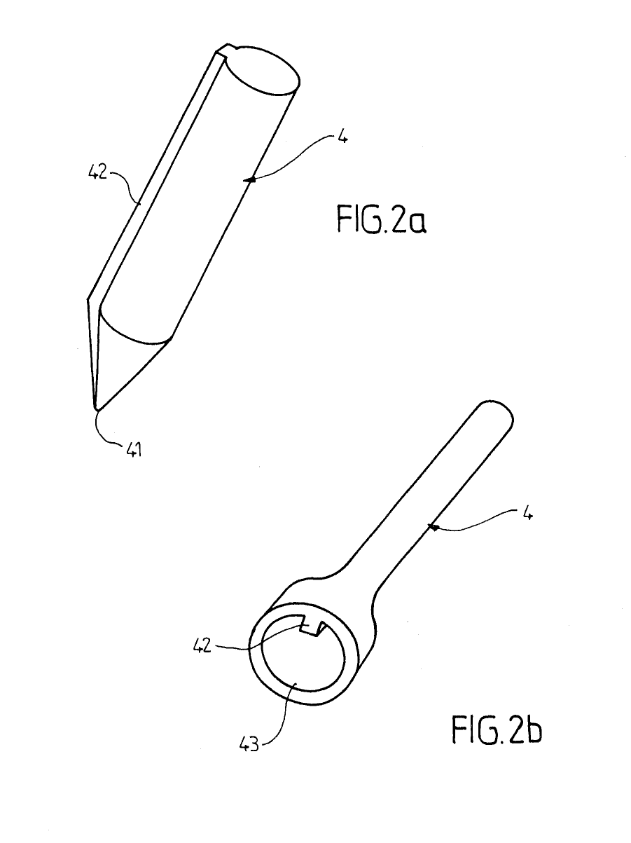

FIGS. 2a and 2b show a perspective view of a punch type tool by means of which the method, object of the invention, can be implemented as shown in FIGS. 1a to 1c and, respectively, according to a nonlimiting variant;

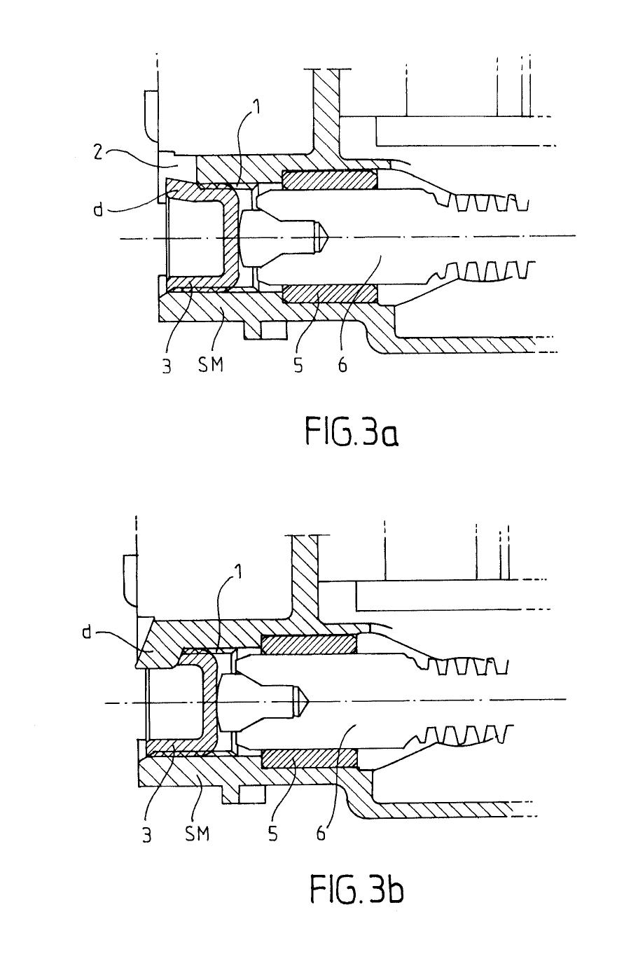

FIGS. 3a and 3b show a view in section through a longitudinal plane of symmetry of a windshield wiper motor equipped with a system for permanently securing the screw for compensating for the axial play of the armature shaft of this motor, according to the implementation in accordance with the method shown in FIGS. 1a to 1c and according to the abovementioned nonlimiting variant.

A more detailed description of the method for permanently securing a screw for compensating for the axial play of the armature shaft of a windshield wiper motor, in accordance with the object of the present invention, is now given in a preferred nonlimiting implementation, in connection with FIGS. 1a to 1c.

FIG. 1a shows the motor mounting base SM of a windshield wiper motor comprising a tapped bore 1 designed to receive a screw for compensating for the axial play of the armature shaft of the windshield wiper motor. It is indeed understood that, as the compensating screw is screwed axially into the bore 1 of the motor mounting base SM, as far as an abutment position with respect to the armature shaft immobilized on this screw, the latter can prevent axial play of the aforementioned armature shaft. The aforementioned screw is generally indicated as a hollow screw.

As shown moreover in figure la, the method object of the invention consists in creating in the bore 1 at least one surface discontinuity 2 which nonetheless allows the screw to be screwed into the bore as far as the abutment position.

With reference to the same FIG. 1a, it is indicated that the aforementioned discontinuity 2 advantageously consists of a slot or a recess created in the lateral surface of the motor mounting base SM at the bore 1. More specifically, it is indicated that the discontinuity 2 can for example be created during molding of the motor mounting base. The discontinuity 2 can for example consist of a slot of the order of 5 to 8 millimeters wide.

Moreover, as shown in FIG. 1b, the method object of the invention, in the aforementioned preferred embodiment, consists in screwing the screw 3 into the bore as far as the abutment position. This completed operation is shown in the aforementioned FIG. 1b, the compensating screw 3 having been screwed into place in a bore 1 of the motor mounting base SM.

The method object of the invention then consists, as shown in FIG. 1b, in applying at the discontinuity 2 a force for deforming the screw 3 so as to deform the lateral surface of the latter and thus permanently secure the compensating screw 3 by jamming in the discontinuity 2.

More specifically, it is indicated that the operation of applying the deforming force, shown by the arrow labeled D in FIG. 1b, consists for example in applying axially, to the assembly consisting of the screw and bore of the motor mounting base SM, a punch type tool comprising at least one lateral rib for deforming the compensating screw 3 by swaging into the aforementioned discontinuity 2.

The compensating screw 3 having its deformation d swaged into the surface discontinuity 2 of the bore 1 is shown in FIG. 1c.

The preferred nonlimiting implementation shown in FIGS. 1a to 1c does not prejudice implementation variants corresponding to the essential steps of the method as described in the above FIGS. 1a to 1c.

In particular, and according to a noteworthy aspect of the method object of the invention, the method may consist, without departing from the scope of the object of the invention, in creating the surface discontinuity on the lateral surface or the thread of the screw 3, the screw used in this situation having a corresponding recess allowing the screw to be screwed into the bore 1. In this situation, as in the step shown in FIG. 1b, the screw is then screwed into the bore 1 as far as the abutment position. It is then not necessary to create a discontinuity 2 in the lateral surface of the motor mounting base SM and of the bore 1. In this nonlimiting variant of implementation of the method, object of the invention, the force D for deforming the motor mounting base SM and the bore 1 is then applied at the discontinuity of the screw so as to deform the lateral surface of the aforementioned motor mounting base and of the bore 1 and thus permanently secure the compensating screw 3 to the motor mounting base SM at the discontinuity 2 of the screw 3.

The implementation of the method, object of the invention, as shown in FIGS. 1a to 1c is preferred as, first, the motor mounting base can be assembled on a production line with its discontinuity 2 apparent and easily accessible, the punch type tool then being simply applied at the screw 3 whereas, second, the deforming force D to be exerted on the compensating screw 3 so as to swage the latter into the discontinuity 2 of the motor mounting base SM is relatively small. The compensating screw 3 can be a screw made of plastic.

The implementation according to the abovementioned variant involves tracking the position of the slot or discontinuity 2 created on the side wall of the screw 3 so as to apply a deforming force D at the detected discontinuity 2. The deforming force D to then be applied on the edge of the bore 1, in line with the detected slot or discontinuity 2, can then be larger.

A more detailed description of a punch type tool, by means of which the method, object of the invention, can be implemented according to the preferred implementation or, respectively, according to the variant of implementation described above, will now be given in connection with FIGS. 2a and 2b respectively.

FIG. 2a shows the punch type tool by means of which the method, object of the invention, can be implemented in its preferred implementation. Such a tool is advantageously mounted on a machine tool of a production line. Substantially circular in cross section, it has an end point 41 and comprises a rib 42, created along a generator of the substantially circular cross section. This rib continues onto the end point, along a generator line of the cone which constitutes the abovementioned point. It can thus be seen that by applying the tool 4 to the compensating screw 3 in position as shown in FIG. 1b, the rib 42 of this tool being substantially aligned with the discontinuity or the recess 2 created on the bore 1 and the wall of the latter, it is possible to achieve the swaging and deformation d of the compensating screw 3 and of the side wall thereof into the recess or discontinuity 2, as shown in FIG. 1c.

The abovementioned punch-shaped tool is a tool made of special steel used for manufacturing tooling for machine tools.

FIG. 2b, by contrast, shows the punch type tool by means of which the method, object of the invention, can be implemented according to the variant of implementation described above when the deforming force D is applied on the outer wall of the bore 1. This tool can advantageously also be mounted on a machine tool of a production line. Also substantially circular in cross section, it has, however, a substantially circular housing 43 at its working end. The circular housing 43 also has a rib 42 having substantially the same role as the rib 42 shown and described in relation to the tool shown in FIG. 2a. When the deforming force D is applied, the rib 42 makes it possible to swage the wall of the motor mounting base SM close to the bore 1 and thus produces a local swaging of the wall of the motor mounting base into the discontinuity 2 of the screw. This variant of implementation can be carried out when the motor mounting base SM is made of Zamac or of aluminum alloy.

Of course, implementation of the method object of the invention, both in its preferred version and in the variant described above, covers the use of punch type tools comprising multiple ribs, wherein a corresponding number of discontinuities 2 can be created on the wall of the bore 1 or, respectively, on the side wall of the screw 3. Finally, a combination of the preferred version and of the abovementioned variant can be carried out without departing from the scope of the object of the present invention.

A more detailed description of a system for permanently securing a screw for compensating for the axial play of the armature shaft of a windshield wiper motor, object of the invention, will now be given in connection with FIG. 3a and FIG. 3b, respectively.

In the abovementioned figures, the same reference signs designate the same elements as above in the description. Moreover, reference sign 5 designates a self-lubricating ring allowing the armature—bearing reference sign 6—to rotate.

It can be seen in FIG. 3a that the surface discontinuity 2 appears on the motor mounting base SM, that is to say at the side wall of the bore 1, and that the deformation d appears on the surface of the compensating screw 3.

In FIG. 3b, by contrast, it can be seen that the surface discontinuity 2 created in the compensating screw 3 is in fact masked by the deformation d of the lateral edge of the motor mounting base SM by swaging into the abovementioned surface discontinuity 2.

In both cases, the windshield wiper motor shown in FIGS. 3a and 3b comprises a deformation d created either at the compensating screw 3 or at the bore 1, and thus constitutes a permanent securing system as described above.

1. A method for permanently securing a screw for compensating for the axial play of the armature shaft of a windshield wiper motor, the compensating screw being screwed axially into a bore of the motor mounting base (SM) as far as an abutment position with respect to the armature shaft which is immobilized thereon, the method comprising:
creating, in the bore and/or the thread of the screw , at least one surface discontinuity allowing the screw to be screwed into the bore as far as the abutment position;
screwing the screw into the bore as far as the abutment position; and
applying, at said discontinuity, a force for deforming the screw and/or the motor mounting base so as to deform the lateral surface of the screw and/or of the motor mounting base and so as to permanently secure the screw and/or the motor mounting base by jamming in said discontinuity.

2. The method as claimed in claim 1, wherein said discontinuity is a slot or a recess created on the lateral surface of the motor mounting base or of the screw .

3. The method as claimed in claim 1, wherein, the operation of applying a deforming force comprises applying axially, to the assembly consisting of the screw and bore of the motor mounting base, a punch type tool comprising at least one lateral rib for deforming the screw and/or the bore by swaging into the corresponding discontinuity.

4. The method as claimed in claim 3, wherein the punch type tool is mounted on a machine tool of a production line.

5. The method as claimed in claim 3, wherein the punch type tool is substantially circular in cross section, said tool having an end point and comprising a rib created along a generator of said substantially circular cross section, said rib continuing onto said end point.

6. The method as claimed in claim 3, wherein the punch type tool is substantially circular in cross section, said tool having a circular housing at its working end, said circular housing having a rib.

7. The method as claimed in claim 1, wherein said discontinuity consists of a slot or a recess created in the lateral surface of the motor mounting base at the bore, said discontinuity being produced during molding of the motor mounting base.

8. A system for permanently securing a screw for compensating for the axial play of the armature shaft of a windshield wiper motor, the compensating screw being screwed axially into a bore of the motor mounting base as far as an abutment position with respect to the armature shaft which is immobilized thereon, the system comprising:
a surface discontinuity created in the bore and/or the thread of the screw; and
a deformation of the screw and/or of the motor mounting base permanently securing the screw and/or the motor mounting base by jamming in said discontinuity.

9. The securing system as claimed in claim 8, wherein said discontinuity is a slot or a recess created on the lateral surface of the motor mounting base or of the screw.

10. The securing system as claimed in claim 8, wherein said deformation is produced by swaging the screw and/or said motor mounting base (SM) into said discontinuity.

11. The securing system as claimed in claim 8, wherein said screw is a hollow screw.

12. The securing system as claim 8, wherein said screw is a plastic screw.

13. The securing system as claimed in claim 8, wherein said motor mounting base (SM) is made of Zamac or aluminum alloy.

14. The securing system as claimed in claim 8, wherein said discontinuity consists of a slot of the order of 5 to 8 millimeters wide.

15. A windshield wiper motor comprising:
an armature shaft immobilized on a screw , for compensating for the axial play of the armature shaft, which is screwed into a bore of the motor mounting base as far as an abutment position, wherein
the compensating screw and/or the bore of the motor mounting base (SM) comprise at least one deformation constituting a permanent securing system as claimed in claim 8.
